(19) United States
(12) Patent Application Publication
(10) Pub. No.: US 2025/0214767 A1
(43) Pub. Date: Jul. 3, 2025

(54) GRAVITY ACTUATED DEVICE TO RESTRAIN OR RELEASE LID OF A REFUSE CONTAINER

(71) Applicant: Jason K Lovett, Griffin, GA (US)

(72) Inventor: Jason K Lovett, Griffin, GA (US)

(21) Appl. No.: 19/006,456

(22) Filed: Dec. 31, 2024

Related U.S. Application Data
(60) Provisional application No. 63/616,696, filed on Dec. 31, 2023.

(51) Int. Cl. B65F 1/16; E05B 15/00

(52) U.S. Cl. CPC B65F 1/1615; E05B 15/0093; B65F 2001/1653; B65F 2210/148

(57) ABSTRACT

A gravity-actuated rotatable device and lid retaining mechanism for a refuse container of the type having an overhead lid, comprising two right-angled, vertical cantilever beams rigidly connected at their upper ends to a common overhead restraining bar, and at their lower ends, pivotally connected to two respective rotator packs, the rotator packs being spaced apart and mounted to the front wall of the refuse container wherein at least one of the rotator packs comprises an assemblage of metal plates, each having sculpted internal channels housing a stainless-steel ball which, in a static ground position is in a blocking position preventing movement of the cantilever beams, and upon lifting and tilting the refuse container, the steel ball is forced by gravity to roll into a release position allowing pivotal movement of both cantilever beams, which simultaneously move the restraining bar clear of the refuse container lid.

### CROSS-REFERENCES TO RELATED APPLICATIONS

This application claims the benefit of priority from previously filed U.S. provisional patent application, Ser. No. 63/616,696, filed on Dec. 31, 2023, further claiming the benefit of the content of said provisional patent application as though fully appearing herein.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### BACKGROUND OF THE INVENTION

### (1) Field of the Invention

The field of the present inventive concept relates generally to refuse waste containers and particularly, devices and/or methods for safely restraining and/or locking in place a hinged, top-mounted lid of a refuse container. Refuse containers, commonly referred to as trash or waste “dumpsters,” are used near multi-unit residential complexes and also in industrial areas. A refuse container is typically a box-like structure having a self-supporting ground base. The general form is usually a block-shaped container with a hinged lid attached to the top surfaces of the perimetral walls thereof.

The predominance of waste containers, when full, are operated by mechanized lifting apparatuses affixed to trucks or other motorized vehicles, which enable grasping of the waste container, pivoting it overhead in some fashion so that the hinged, top-mounted lid of the container opens, and the trash contained therein is emptied into the vehicle.

The container is then lowered and replaced in its position on the ground or other hard surface, and the hinged lid closes atop the container. In recent years, industrial theft has become a problem and, to prevent unauthorized use or possible access to confidentially-designed components, refuse containers may also be equipped with a method of locking and/or restricting use of the lid atop the refuse container.

### (2) Description of the Related Art, Including Information Disclosed Under 37 CFR 1.97 and 1.98

U.S. Pat. No. 5,094,358 B2 Serio, Sr. (1991) An automatic locking mechanism for a dumpster ball trigger 7 is used to release an angled lever to unlock [See FIG. 2, FIG. 3, FIG. 4]. Features an automatic pivoting locking mechanism having a wedge assembly, the wedge assembly further comprising a ball trigger 7 used instead of hinged wedge plate 1. [Claim 4].

U.S. Pat. No. 5,2010,434 DeVivo; Dumpster with locking bar across its lid. A link pivotally connected with lock bar and slide arms.

U.S. Pat. No. 5,474,341 Putman; Has a roller 62, which is confined in a railing 50. The roller is held in a lever lock position by gravity. Roller moves out of lock position when container side is lifted to an angle with the vertical greater than the leaver lock angle.

U.S. Pat. No. 5,599,050 Tinsley; When the trash container is rotated for emptying, a gravity lock rotates, freeing the turn stop to rotate and thereby allowing the through-shaft and bar to tilt backwards and release the lid.

U.S. Pat. No. 5,662,364; Reeb 1995; Latching mechanism comprising a slide plate, cable spring, guide member for slide plate, and a trigger ball 40 (housed with a slot 32) being provided in the slide plate 32 which blocks movement of the slide arm in the latched position. When container is tipped forward, gravity moves the ball 40 out of the slot and acts on the lock-acts on the locking bar to cause a tension in the cable; slide member rotates to unlocked position.

EP 899,216; Reeb A lock releasing mechanism for a container with a hinged lid. Some elements of the locking mechanism comprise a trigger ball 40 which blocks movement of a slide

U.S. Pat. No. 5,997,052; Reeb 1997; A trigger ball 40 is dislodged from a slot 36 in a slide plate 32 by the force of gravity (FIG. 5); the slide plate 32 is then free to move in response to a tension a cable 24. When container 10 is in a substantially level position, a spring biases the slide plate 32 toward a locked position. When the trigger ball 40 is trapped in both slots, 32 and 36, the locking mechanism 30 is placed in the locking position (Col. 5, lines 1-4).

U.S. Pat. No. 6,733,053; Hodge 2002; a locking arm having a central portion and first and second end portions bent perpendicular to the central portion; first and second pivot brackets for mounting on opposite walls of a trash container; each pivot bracket comprising a U-shaped member and a pivot pin 28 extending between the ends of the U-shaped member

U.S. Pat. No. 9,580,243 Reeb; 2014 A locking device features a stop member 32, and a rolling member 34 (also called a spherical ball 34) which is moveable on a slanted ramp 30 between the stop member 32 and the side wall 23 of the casing 16 (Col. 6, lines 51-63). With the container upright on the ground, the rolling member 34 is maintained in the first blocking position—by gravity (FIGS. 5-7); Prevents the locking bar 6 from rotating relative to waste container. (Col. 8, lines 40-60).

U.S. Pat. No. 10,287,095; Reeb & Martin; FIG. 7B discloses a rolling member 140 disposed within a slot which is part of an angularly disposed slot as part of the mechanism. The rolling member 140 may be in the form of a spherical ball or a cylindrical disc. When the container is in an upright position (tilted forward), the rolling member 140 is pulled by gravity into an opened position.

### BRIEF SUMMARY OF THE INVENTION

Disclosed herein is a gravity actuated rotatable device 1 having a horizontal, elongated restraining bar 7, which is operated by pivotal movement of two vertically oriented, L-shaped (right-angled) cantilever beams 10, 20 rigidly attached, at their upper ends, to the restraining bar 7. The two cantilever beams 10, 20 are attached at their respective lower ends to the front wall 52 of a refuse container 50 and rotate in the range of an arc C-C, simultaneously repositioning the restraining bar 7. The lower end of each cantilever beam 10, 20 is pivotally coupled or rotatably connected, through respective left and right rotator packs 30, 40 to the front wall 52 of the refuse container 50.
the restraining bar 7 of the gravity-actuated rotatable device 1 (referred to herein as “GARD” 1) is normally positioned horizontally directly over the upper surface of the lid 51 of the refuse container 50, preventing opening of the lid 51. When the refuse container 50 is lifted from its static resting position and tilted forward, a gravity-actuated mechanism inside at least one of the rotator packs 30, 40 forces its respective cantilever beam 10, 20, to pivot downward, bringing the restraining bar 7 into a retracted position, spaced apart from the lid 51.

Either one or both rotator packs 30, 40 may be constructed with the gravity-actuated mechanism. In the preferred embodiment, the left rotator pack 30 is constructed with the gravity actuated mechanism, and also is constructed with a means for mechanically locking the left cantilever beam 10.

### BRIEF DESCRIPTION OF THE VIEWS OF THE DRAWINGS AS EXEMPLARY EMBODIMENTS OF THE INVENTIVE CONCEPT

FIG. 1 is a direct frontal view of a refuse container 50 having the GARD 1 with a left rotator pack 30 and right rotator pack 40 both connected to the front wall 52 of the refuse container 50, causing the restraining bar 7 to be positioned proximate the top of the lid 51 of the refuse container 50.

FIG. 2 displays a partial view of the right wall 54 of the refuse container 50 which is in a static rest position atop a flat, or ground surface 57, further showing the left cantilever beam 10, restraining bar 7, and the left rotator pack 30.

FIG. 3 illustrates the refuse container 50 of FIG. 1, having been lifted upward and tilted forward, causing both cantilever beams 10, 20 (hidden from view) to pivot, freeing the lid 51 of the refuse container 50 to open, discharging the contents of the container 50.

FIG. 3A is an isolated profile view of the left cantilever beam 10, showing its left lockbar arm 11 and left shoulder 13.

FIG. 3B illustrates the interior surface 11(c) of the left lockbar arm 11 of the left cantilever beam 10.

FIG. 3C displays the exterior upper surface 13(a) of the left shoulder 13 of the left cantilever beam 10.

FIG. 4 presents a closeup view of the left cantilever beam 10, as attached to its left rotator pack 30, including the left bracket plate 31, the assemblage of individual plates 32-36, the left lockbar arm 11, left elbow 12, left shoulder 13, and a portion of the restraining bar 7.

FIG. 5 is a planar view of the exterior surface 31(a) of a left bracket plate 31, the first sequential plate integral to five other conjoined and similarly sized plates 32-36 of the left rotator pack 30.

FIG. 6 represents a planar view of a locking plate 32, along with its first channel 60 and a padlock entry tab 63.

FIG. 7 is a planar view of a triggering plate 33, further presenting a view of the trigger 37 mechanism that is positioned to function in coordination with the padlock entry tab 63 of the adjacent locking plate 32.

FIG. 8 is a planar view of a housing plate 34, which provides an open space 9, serves to house and guide the lower end of the left lockbar arm 11 in a confined plane.

FIG. 9 illustrates a planar view of the left guide plate 35, along with an internally contoured second channel 61.

FIG. 10 is a planar view of a cover plate 36, the right exterior plate of the left rotator pack 30.

FIG. 11 is a planar view of the exterior surface 41(a) of the right bracket plate 41, being the first sequential plate conjoined with five other similarly sized plates 42-46 of the right rotator pack 40.

FIGS. 12A through 12E present sequential views of the remaining five plates 42-46 of the right rotator pack 40, the plates forming a functional assemblage, sequentially joined to the right bracket plate 41.

FIG. 13 is a sectional view of the left rotator pack 30, revealing the housing plate 43, in accordance with section line A-A of FIG. 4, and also, partially in accordance with section line D-D of FIG. 13A. Further shown are the left lockbar arm 11, left shoulder 13, and the left end of the restraining bar 7.

FIG. 13A is a view of plates 31-36 of the left rotator pack 30, in accordance with section line B-B of FIG. 4. Further shown is the outline of the stainless-steel ball 5 occupying the empty volumes in channel 60 of the left locking plate 32 and channel 61 of the guide plate 35.

FIG. 14 depicts the refuse container 50 having been lifted and tilted overhead, further showing internal mechanical relationships within the left housing plate 34, of the left rotator pack 30.

TABLE of Nomenclature & Part Numbers of Rotatable Device

1. Gravity-actuated rotatable device
(GARD)
2.-3. n/a.
4. Hole
5. Stainless steel ball
6. Brace
7. Restraining bar
8. Weld
9. Plate open space
10. Left cantilever beam
11. Left lockbar arm
11(a) Left arm outer surface
11(b) Left arm rear surface
11(c) Left arm inner surface
(c) Left arm inner surface
12. Left elbow
13. Left shoulder
13(a) Shoulder outer surface
13(b) Shoulder terminal
14. Footing
15. Left arc
16. Catch
17. Left stop
18.-19. n/a
20. Right cantilever beam
21. Right lockbar arm
21(a) Right arm outer surface
22. Right elbow
23. Right shoulder
23(a) Shoulder inner surface
23(b) Shoulder terminal
24. Right footing
25. Right arc
26. Catch
27. Right stop
28.-29. T/B/D
30 Left rotator pack
31. Left bracket plate
31(a) Outer surface of 31
31(b) Flange
32. Locking plate
33. Trigger plate
34. Housing plate
35. Guide plate
36. Cover plate
37. Trigger
38. Through-rod
39. Through-orifice
40. Right rotator pack
41. Right bracket plate
41(a) Outer surface of 41
41(b) Inner surface of 41
41(c) Flange
42. Locking plate
43. Triggering plate
44. Housing plate
45. Guide plate
46. Cover plate
47.-49. n/a
50. Refuse container
51. Topside lid
52. Front wall
53. Left wall
54. Right wall
55. Sleeve
56. Lifting apparatus
57. Ground surface
58.-59. n/a
60. First channel
61. Second channel
62. Bay
63. Padlock entry tab
63(a) Padlock opening
63(b) Second padlock opening
64. Axle orifice
65. Left axle
66. Right axle

### DETAILED DESCRIPTION OF THE INVENTIVE CONCEPT

The objects, features, and advantages of the inventive concept presented in this application are more readily understood when referring to the accompanying drawings. The drawings, totaling twenty-two figures, show the basic components and functions of embodiments and/or methods of use. In these figures, like reference numbers are used in each figure to correspond to the same component as may be depicted in other figures.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The characterizations of various components and orientations described herein as being “vertical”, “horizontal”, “upright”, “right”, “left”, “side”, “top”, or “bottom” designate directions in the drawings to which reference is made and are relative characterizations only based upon the particular position or orientation of a given component as illustrated. These terms shall not be regarded as limiting the invention. The words “downward” and “upward” refer to position in a vertical direction relative to a geometric center of the apparatus of the present invention and/or designated parts thereof.

The terminology includes the words above specifically mentioned, derivatives thereof and words of similar import. It is to be noted that, although some drawing figures contain dimensions of parts and components, these dimensions are not intended to limit or confine the size of those components but are cited merely as a guideline for tooling.

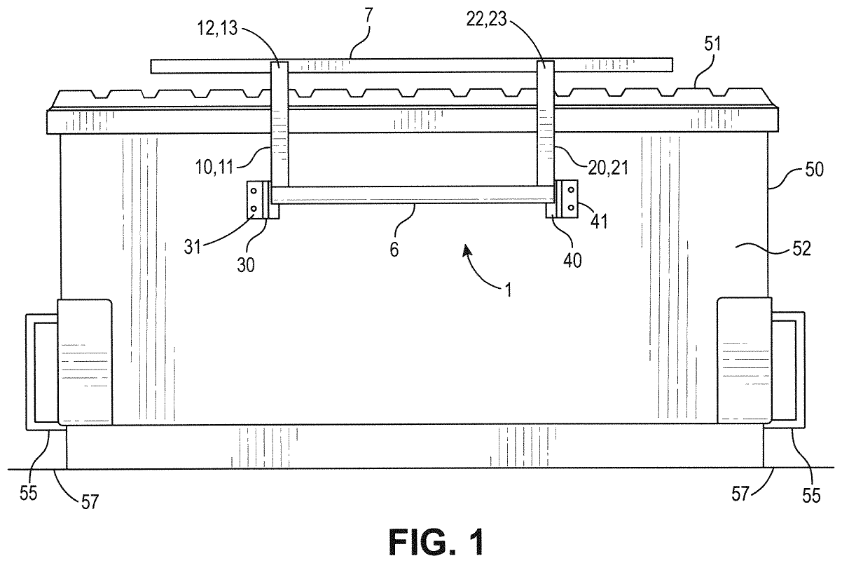

The discussion of the present inventive concept is initiated referencing FIG. 1, which illustrates the GARD 1 attached to a refuse container 50. The disclosed GARD 1 comprises five primary components, being operationally related as:
(1) a left L-shaped, cantilever beam 10;
(2) a right L-shaped cantilever beam 20, both cantilever beams 10, 20 being vertically oriented and rigidly attached at their respective upper ends to
(3) a horizontally oriented retaining bar 7, further both cantilever beams 10, 20 being pivotally attached at their respective lower ends to
(4) a left rotator pack 30, and (5) a right rotator pack 40, respectively.

FIG. 1 presents a direct view of a refuse container 50 with the GARD 1 attached to the front wall 52 of the refuse container 50. There is further shown a restraining bar 7 horizontally attached to the left cantilever beam 10 and the right cantilever beam 20. Each cantilever beam 10, 20 is connected at its respective lower end to a left rotator pack 30 and a right rotator pack 40, and further, a horizontal brace 6. In turn, each rotator pack 30, 40 is pivotally attached, by means of respective bracket plates 31, 41 to the front wall 52 of the refuse container 50. The attachment of the bracket plates 31, 41 may be facilitated by bolts, welding, or other methods of providing permanent fastening. The horizontal brace 6 adds rigidity and lateral strength to the GARD 1.

In FIG. 1, the refuse container 50 is shown stationary atop the ground or other flat surface 57. Further illustrated are left and right sleeves 55, integral to the refuse container 50, which serve as insertion points for mechanical lifting arms commonly used by industrial trucks that lift and otherwise maneuver refuse containers.

Each cantilever beam 10, 20, comprises a vertically-oriented lockbar arm 11, 21, both lockbar arms 11, 21 joined at a ninety-degree elbow 12, 22 to their respective horizontally-oriented shoulders 13, 23. The two cantilever beams 10, 20 are spaced apart horizontally, a distance slightly less than the length of the horizontally-attached restraining bar 7 to which the two cantilever beams 10, 20 are affixed.

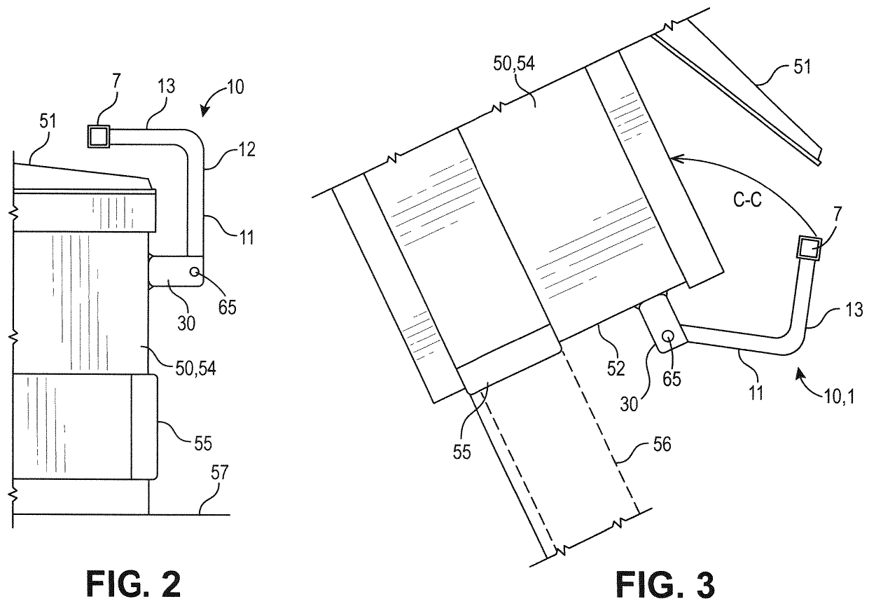

FIG. 2 provides a partial view of the right wall 54 of the refuse container 50 of FIG. 1 and the relative positioning of the left cantilever beam 10. The restraining bar 7 is seen positioned proximate the top surface of the lid 51 of the refuse container 50. Both the left cantilever beam 10 and right cantilever beam 20 (hidden from view) are oriented vertically in their normal static position.

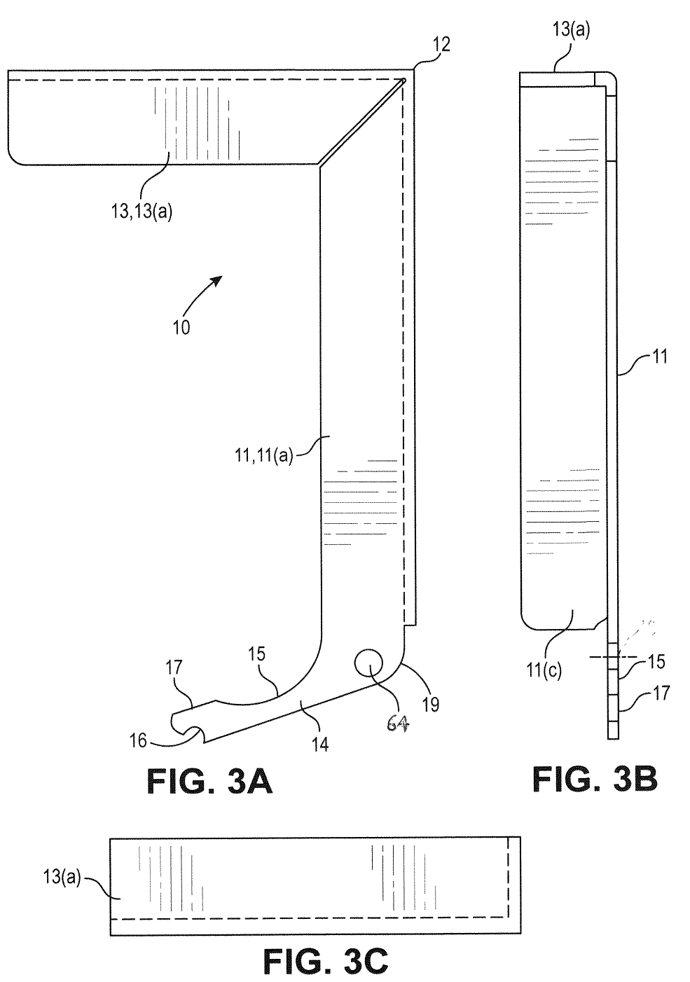

FIG. 3 illustrates the refuse container 50 having been raised from the ground surface 57 and tilted forward by the 7 lifting mechanism 56 of a heavy-duty industrial truck. The tilting maneuver sets in motion a stainless-steel ball within at least one of the rotator packs 30, 40 of the GARD 1, freeing both the left cantilever beam 10, and right cantilever beam 20 (not in view) to pivot about an axle 65 and away from the refuse container 50. In this manner, the restraining bar 7 is induced to travel along the path of arc C-C, away from the lid 51 of the refuse container 50 and allows the refuse container 50 lid 51 to fall open.

FIG. 3A shows, for further clarification, the profile and relative dimensions of the L-shaped left cantilever beam 10. FIG. 3A illustrates the left cantilever beam 10 comprises a left lockbar arm 11, a left shoulder 13, and an elbow 12. Additional structural components of the left cantilever beam 10 include its “lower end” parts, being a footing 14, a left arc 15, a catch 16, a left stop 17, and a heel 19. By specific design, the above lower end components of the lockbar arm 11 are constructed of dimensions which allow fit inside the open space 9 within the housing plate 34 of the left rotator pack 30.

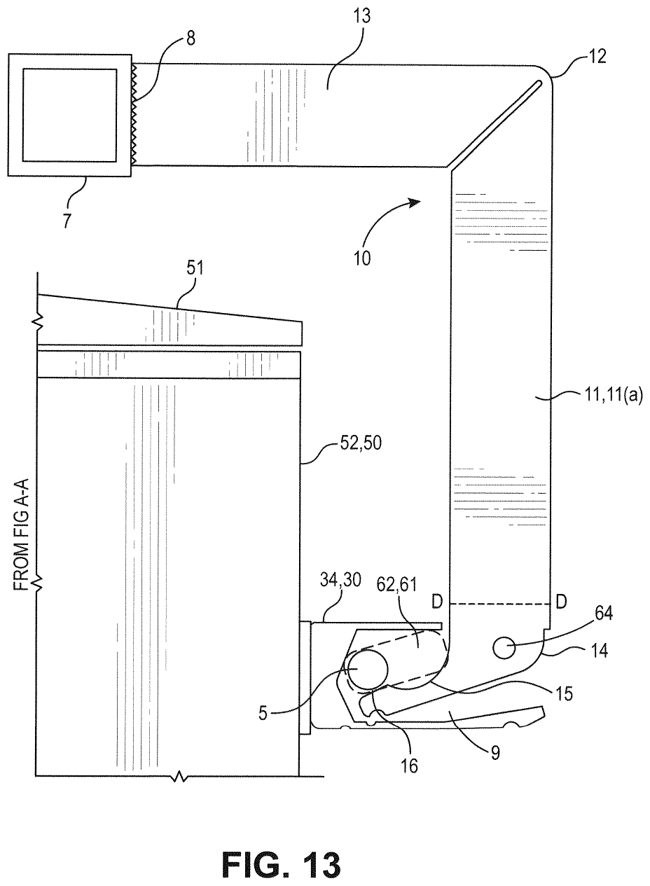

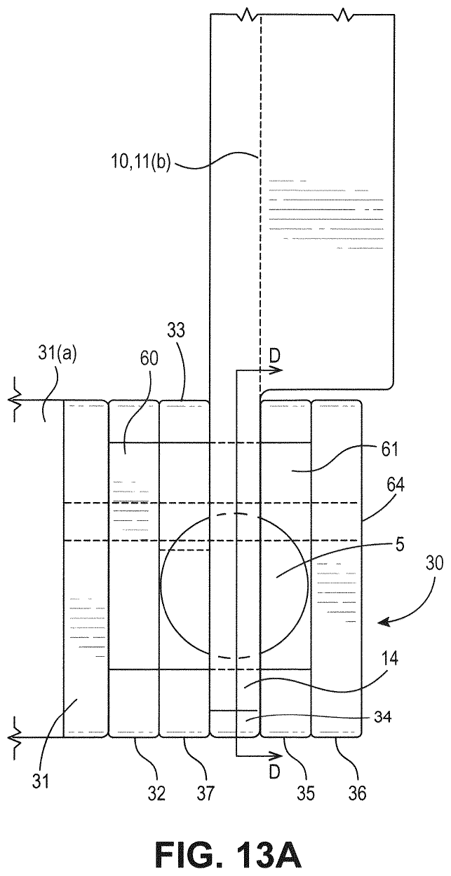

The lower end components of the lockbar arm 11 and their spatial relationship within the housing plate 34 are further understood by viewing FIG. 8 and FIG. 13, infra. Also shown in FIG. 3A is a left heel aperture 18. The left heel aperture 18 permits insertion of an axle 65 about which the heel 19 and lower end of the left cantilever beam 10 will rotate when the refuse container 50 is tilted. FIG. 3B depicts a profile view of the left cantilever beam 10 of FIG. 3A, including the contour of the inner surface 11(c) of the lockbar arm 11. FIG. 3C presents a downward looking view of the outer surface 13(a) left shoulder 13 of the left cantilever beam 10.

The features described immediately above similarly apply to the right cantilever beam 20. The right cantilever beam 20 features the inner and outer surfaces of its right lockbar arm 21 and right shoulder 23 conversely arranged, compared to the left cantilever beam 10. The detailed discussion of the construction and function of the left cantilever beam 10 is presented as a means of also illustrating the scope, dimensions, and functionality of the right cantilever beam 20.

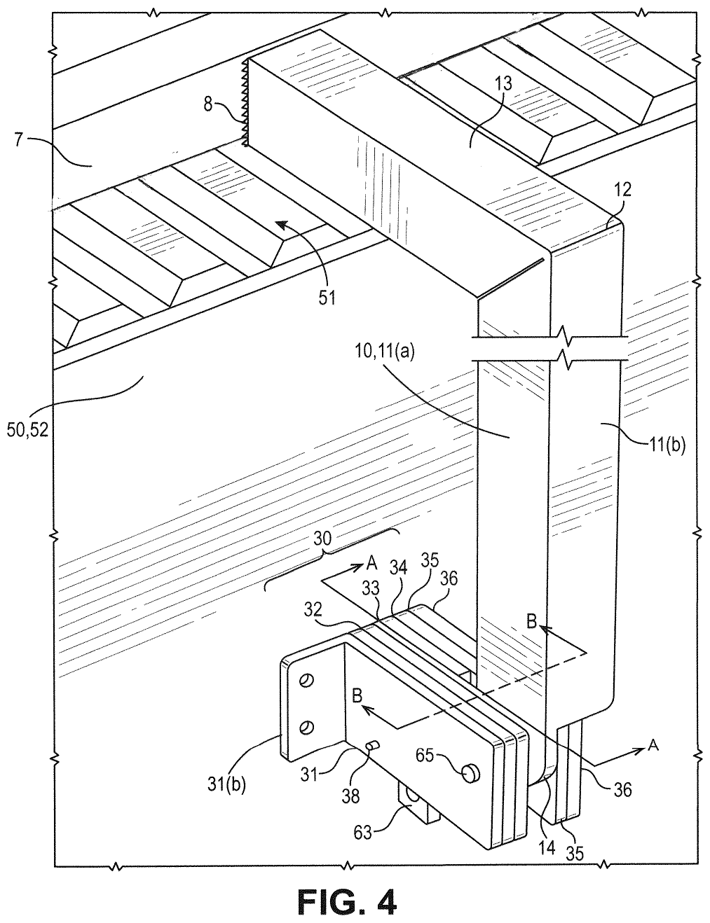

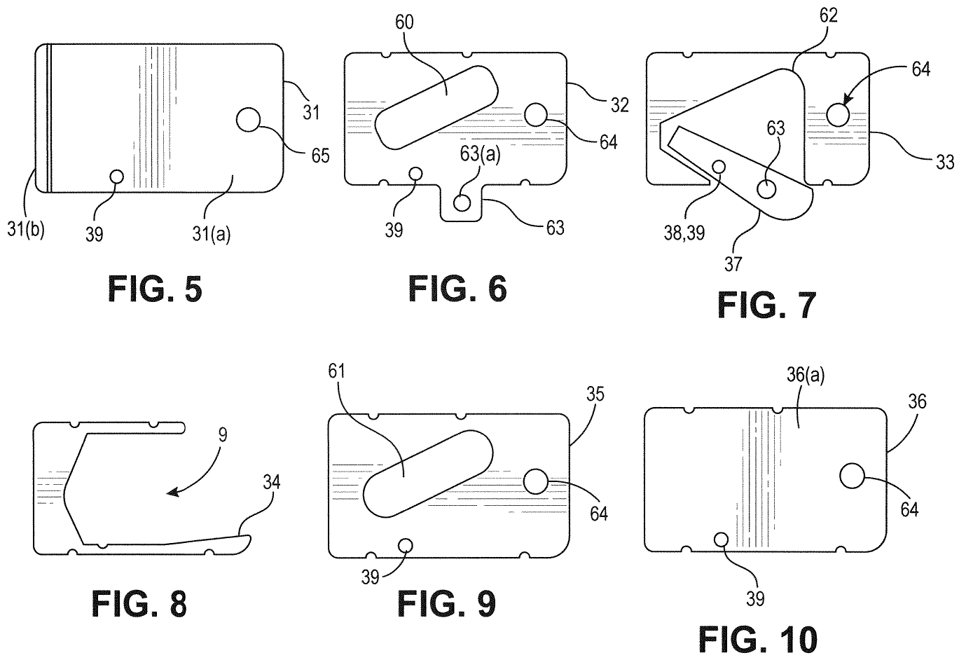

FIG. 4 is an expanded closeup view of the left cantilever beam 10 shown in its normal functional orientation pivotally joined to the left rotator pack 30. The individual sequentially arranged plates 31-36 of the left rotator pack 30 form an assemblage which is illustrated in FIG. 4. These left plates 31-36 are also illustrated in, FIG. 5 through FIG. 10, in the order of their arrangement within the left rotator pack 30. FIG. 4 illustrates that the left rotator pack 30 comprises a series of six coordinated, same-sized metal plates 31-36, the planar faces of the plates sequentially assembled and permanently joined in planar abutment to each other.

For purposes of illustration, and not as a means of limitation, the structure and function of both the left cantilever beam 10 and the right cantilever beam 20 and their associated rotator packs 30, 40, are discussed by reference to FIG. 4. The left cantilever beam 10 is shown rigidly attached at its upper end by a weld 8 to the horizontally oriented restraining bar 7. The orientation illustrated in FIG. 4 shows the position of the restraining bar 7 prevents opening of the lid 51 of the refuse container 50.

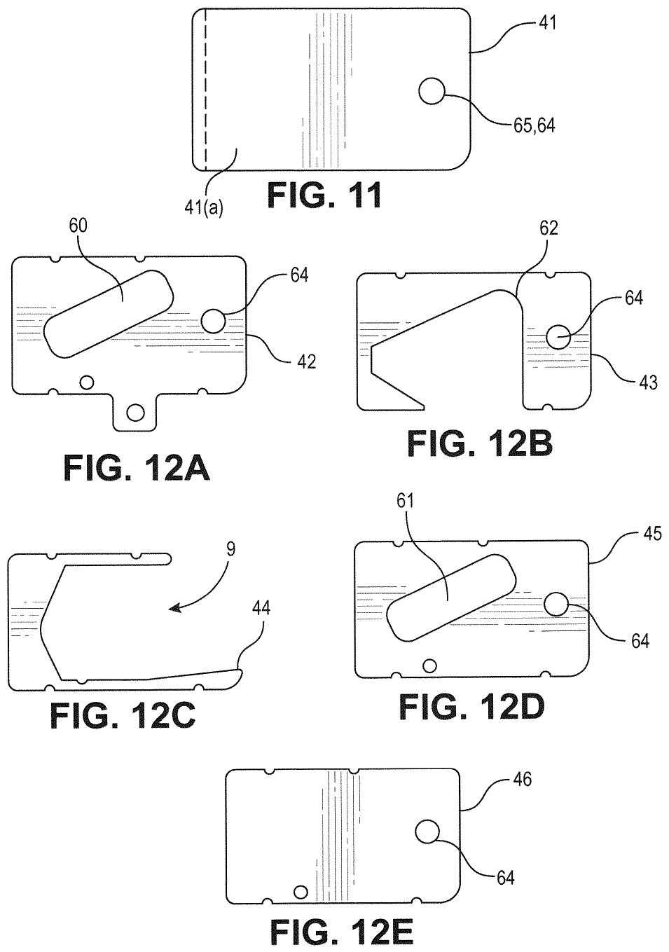

It is to be noted, in FIG. 4, that the left outermost plate of the left rotator pack 30 is the left bracket plate 31, also shown in both FIG. 4 and FIG. 5. The embodiment shown in FIG. 4 displays the left bracket plate 31 having an orthogonally oriented flange 31(b), which flange is utilized to facilitate connection of the left rotator pack 30 to the front wall of the refuse container 50. The right outermost plate of the right rotator pack 40 is the right bracket 41, shown in FIG. 11. The right bracket plate 41 likewise is constructed with an orthogonally-oriented flange 41(b), which flange facilitates connection of the right rotator pack 40 to the front wall of the refuse container 50.

In FIG. 4 there is placed a section line, B-B, which indicates the orientation of a cutaway view of the left rotator pack 30 and the left cantilever beam 10. In this manner, the internal positioning of the left cantilever beam 10. The perspective, seen from section line B-B is presented in FIG. 13A, wherein all six of the plates, 31 through 36 are shown, as well as the relative containment of the stainless-steel ball 5.

FIG. 5 through FIG. 10 illustrate the individual coordinated plates 31-36 of the left rotator pack 30 in their sequential order. Beginning with FIG. 5, there is shown a view of the outer surface 31(a) and the flange 31(b) of the left bracket plate 31. An axle orifice 64, common to left plates 31, 32, 33, 35, and 36, is provided to accommodate an axle 65 about which the left rotator pack 30 and left cantilever beam 10 rotate during pivoting of both the left and right cantilever beams 10, 20. The left bracket 31 is the only part of the left rotator pack 30 attached to the front wall 52 of the refuse container 50, by means of bolting through the two holes 4 shown, by welding, or other attachment means.

FIG. 6 displays the locking plate 32 of the left rotator pack 30 which contains an oblong, slanted, first channel 60, the common axle orifice 64, a padlock entry tab 63, and a padlock opening 63(a). The padlock entry tab 63 and opening 63(a) provide the means by which the GARD 1 may be mechanically locked. A user must insert one shackle of a padlock through both the padlock opening 63(a) and a second padlock opening 63(b) within the device trigger 37, shown in FIG. 7.

A through-orifice 39, appearing in all metal plates, provides an opening to accommodate a through-rod 38 about which the device trigger 37 may rotate during routine operation of both rotator packs 30, 40. The first channel 60, shown in FIG. 6, provides internal support for a portion of the periphery of the stainless-steel ball 5 during functional rolling movement of the stainless-steel ball 5. Similarly, a second channel 61 is placed in the guide plate 35, and serves the same function.

FIG. 7 illustrates the housing plate 33 of the left rotator pack 30, constructed with a triangular-shaped open bay 62 and the common axle orifice 64. The open bay 62 of the housing plate 33 is constructed to coincide with the (a) upper angular edge and (b) length of both the first channel 60 and second channel 61 in the locking plate 32 and guide plate 35, respectively. Both channels 60, 61 also provide partial internal support for the stainless ball 5. This relationship is more clearly shown by viewing FIG. 13A,

Manual locking of the GARD 1 may be accomplished by coordinated utilization of both the locking plate 32 of the left rotator pack 30 and the trigger device 37 of the trigger plate 33. Locking is accomplished by a user rotating the trigger 37 about the through-rod 38 until the trigger's (37) second padlock opening 63(b) is aligned with the padlock opening 63(a) of the adjacent trigger plate 33. At that point, the shackle or shank of a padlock may be inserted through both openings 63(a), 63(b) and locked firmly.

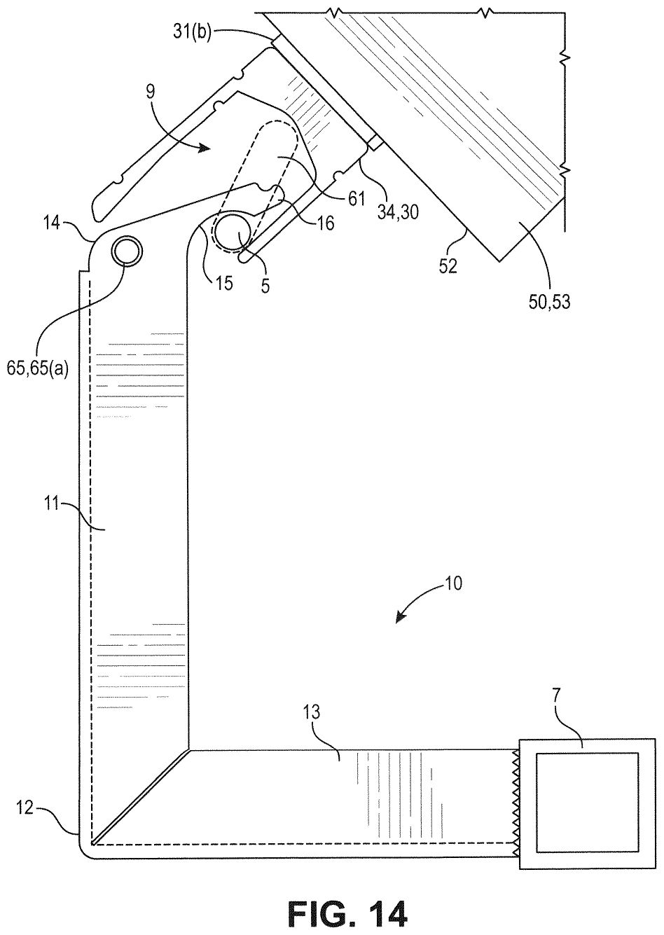

FIG. 8 is a planar view of the housing plate 34 which is constructed with a U-shaped open space 9, the open space 9 allowing room for movement of the lower end of the left lockbar arm 11 in the range of a confined arc. FIG. 13 and FIG. 14, infra, illustrate the range of motion allowed the lower end of the left lockbar arm 10 within the open space 62 of the housing plate 34.

FIG. 9 displays a planar view of the guide plate 35, which comprises a downward-sloping, oblong-shaped second channel 61, the common axle orifice 64, and the through-orifice 39. The second channel 61 provides lower support for a portion of the periphery of the stainless-steel ball 5 during back-and-forth movement of the stainless-steel ball 5.

FIG. 10 illustrates the inner surface 36(a) of the left cover plate 36, further displaying its through-orifice 39 and axle orifice 64. Plates 31-36 are constructed having inner channels, contours, and cavities which are arranged and coordinated so as to guide and control (a) the movement of the internal steel ball 5 and (b) pivoting of the lower end of the left cantilever beam 10. The left bracket plate 31, locking plate 32, trigger plate 33, and guide plate 35 contain the same size, concentric holes 39 which accommodate a small linear rod 38 about which the device trigger 37 may swing freely and positioned for locking the GARD 1.

In the same manner, FIG. 11, along with FIG. 12A through 12E present planar views of the sequential series of the six coordinated plates 41-46 of the right rotator pack 40. Plates 42 through 45 of the right rotator pack 40 are also constructed having inner channels, contours, and cavities arranged and coordinated so as to simultaneously guide and control the pivoting of the lower end of the right cantilever beam 20.

The right rotator pack 40 is assembled with the planar faces of plates 41-46, sequentially arranged and permanently adjoined in planar abutment to each other. In the preferred embodiment, the plates are joined by perimetral welding. Other means of joining may also be utilized. Further, each of the plates 31-36 and 41-46 is ¼ inch thick, further having a planar width and length of 3.0 inches by 5.5 inches, respectively.

FIG. 13 displays a view of the left cantilever beam 10, further supplemented by a rendering of the sectional view of the left rotational pack 34, displayed in accordance with section line D-D of the adjacent FIG. 13A. The placement of section line D-D exposes, in FIG. 13, a sectional view of the left housing plate 34, the stainless-steel ball 5, and the lower end of the left cantilever beam 10.

In FIG. 13, components of the lower end of the left cantilever beam 10 are shown to be the catch 16, the left arc 15, the footing 14. Also in view is an axle orifice 64 utilized to enclose a width-wise axle 65, about which the left rotator pack 30 pivots when the refuse container 50 is lifted and tilted forward.

The orientation of the left cantilever beam 10 in FIG. 13 shows the restraining bar 7 positioned above the refuse container 50, preventing full opening of the lid 51. Further, the stainless-steel ball 5 is thusly constrained by (a) the rearward edge of the housing plate 34, (b) the catch 16 of the lockbar arm 11, (c) the downward slope of the bay 62 of the trigger plate 37, and (d) the downward slope of the second channel 61 of the housing plate 34.

FIG. 13 and FIG. 13A both confirm that the stainless-steel ball 5 is confined within the internal contours of metal plates 33, 34, and 35. It is to be noted that the left footing 14 is housed within the plate open space 9 of the left housing plate 34, along with the stainless-steel ball 5. By virtue of the downward slanting orientation of the footing 14 of the lockbar arm 11, and the downward slant of the second channel 61 of guide plate 35, the stainless-steel ball 5 cannot move upward, and therefore prevents the footing 14 from moving in a clockwise direction. As additional restriction to the rearward rotation of the lockbar arm 11, the oblong-shaped first channel 60 of the adjacent locking plate 32 (not in view) also prohibits movement of the stainless-steel ball 5.

The left footing 14 is shown nestled within the open area 9 of the left housing plate 43, along with a stainless-steel ball 5. The left cantilever beam 10 is therefore positioned so as to place the restraining bar 7 in a “restraining” position, horizontal to, and proximate the upper surface of the lid 51 of the refuse container 50.

FIG. 13A is a sectional view of the left rotator pack 30 as seen from section line B-B of FIG. 4. Further shown is the outline of the stainless-steel ball 5 occupying the empty spatial areas in the first channel 60 of the left locking plate 32 and the second channel 61 of the guide plate 35. The stainless-steel ball 5, rests directly in front of the left arc 15 and upon the ball catch 16 of the left cantilever beam 10. The ball 5 is constructed of stainless steel to prevent corrosion while the GARD 1 is exposed to harsh climatic conditions during exterior use.

By the arrangement shown in FIG. 13A, it can be seen that the sequential order of plates 31 through 36 collectively form the left rotator pack 30. In turn, the left rotator pack 30 enables the essential pivoting action of the left lockbar arm 11, a component of the left cantilever beam 10. Similarly, the sequential order of plates 41 through 46 collectively form the right rotator pack 40 to provide the essential pivoting action of the right lockbar arm 21, part of the right cantilever beam 20.

FIG. 14 presents a sidewise, isolated view of the interior of the left rotator pack 30 with the refuse container 50 having been lifted overhead and tilted forward. It can be seen that the stainless-steel ball 5 has been freed to roll downward, under the pull of gravity, within the confines of the second channel 61 of the guide plate 35 (not in view).

It is to be noted, in FIG. 14, that the left footing 14, left arc 15, and left catch 16 have all been rotated upward within the open area 9 of the left housing plate 34. The stainless-steel ball 5 is confined within the left arc 15 of the lower lockbar arm 11. Unrestrained by the stainless-steel ball 5, the left cantilever beam 10, along with the right cantilever beam 20 (not in view) have pivoted about their common axle 65. Both cantilever beams 10, 20 have dropped toward the ground or flat surface 57, pulling the restraining bar 7 with them. Therefore, the lid 51 of the refuse container 50 is free to swing open.

Once the refuse container 50 is disgorged of its contents, it is then rotated, by the industrial waste truck, back toward the ground surface 57 location. As the refuse container 50 is rotated backwards, gravity acts upon the stainless-steel ball 5, causing it to roll downward within the empty spatial area of the first channel 60 of the left locking plate 32 and that of the second channel 61 of the guide plate 35. In this manner, the weight shift of the stainless-steel ball 5 allows the cantilever beams 10, 20 to pivot about the common axle 65, resuming the placement of the restraining bar 7 above and proximate the lid 51 of the refuse container 50.

While preferred embodiments of the present inventive method have been shown and disclosed herein, it will be obvious to those persons skilled in the art that such embodiments are presented by way of example only, and not as a limitation to the scope of the inventive concept. Numerous variations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, as described by the scope of the claims presented herein.

What is claimed is:

1. A gravity actuated rotatable device for restraining, locking, or releasing the top-mounted lid of a refuse container having a front wall, rear wall, and two side walls, the device comprising:
(a) separate left and right assemblages of six metal plates, each metal plate further having internally contoured openings, with each assemblage being spaced apart and permanently affixed to the front wall of a refuse container;
(b) a stainless-steel ball located in a confined manner within the contoured openings of the adjacent metal plates of at least one of the assemblages;
(c) a left and a right upright cantilever beam, each beam attached at its upper end to a linear restraining bar positioned horizontally, directly above the lid of the refuse container, and each cantilever beam pivotably attached at its lower end to one of the respective assemblages of metal plates; wherein
(d) upon lifting and tipping the refuse container forward from its static ground position, gravity causes the stainless-steel ball to roll within the at least one assemblage of metal plates, thereby allowing its respective cantilever beam to pivot within the assemblage, forcing both cantilever beams to pull the restraining bar away from its position above the lid, permitting opening of the refuse container lid.

2. The gravity-actuated rotatable device of claim 1 wherein at least one assemblage of metal plates is constructed with a locking mechanism comprising (a) a first metal plate having a pivotable trigger with a rounded orifice and (b) a second, adjacent metal plate having, at its bottom edge, a protruding padlock entry tab with a padlock opening, whereupon by aligning the rounded orifice and padlock opening coaxially and inserting the shackle of a padlock through both, the stainless-steel ball is restrained from rolling, immobilizing its respective cantilever beam, preventing opening of the lid.

3. A gravity actuated rotatable device for restraining, locking, or releasing the top-mounted lid of a refuse container having a front wall, rear wall, and two side walls, the device comprising:
a left rotator pack and a right rotator pack, each constructed of six metal plates wielded flush together, in planar abutment, with four adjacent plates further having uniquely contoured interior channels;
the left and right rotator packs being spaced apart and permanently affixed to the front wall of the refuse container;
a stainless-steel ball located within the confines of certain of the interior channels of the left rotator pack;
an L-shaped left cantilever beam vertically attached at its lower end to the left rotator pack and an L-shaped right cantilever beam vertically attached at its lower end to the right rotator pack, and further, each cantilever beam attached, at its respective upper end, to an elongated horizontal restraining bar, such that with the refuse container at rest upon a flat surface, the restraining bar is positioned directly above the lid of the refuse container, blocking opening of the lid; and
upon the refuse container being lifted from the flat surface and its front wall tilted forward, the force of gravity causes the stainless steel ball of in left rotator pack to roll, within the internal channels, freeing the left cantilever beam to pivot downward and pull the restraining bar away from its position above the lid, thus allowing the lid to freely swing open.

4. The gravity-actuated device of claim 3 wherein the left rotator pack has a locking mechanism comprising (a) a first metal plate having a pivotable trigger with a padlock opening and (b) a second, adjacent metal plate having integral to the bottom of the second metal plate a padlock entry tab with a padlock opening, whereupon positioning both padlock openings coaxially and inserting a shackle of a padlock through both padlock openings restricts the trigger, blocks the stainless-steel ball from rolling, and prevents pivoting of the cantilever beam, effectively preventing opening of the lid.

5. A gravity actuated rotatable device for restraining, locking, or releasing the top-mounted lid of a refuse container so equipped, comprising:
(a) left and right upright cantilever beams, each beam attached at its upper end to a linear restraining bar positioned horizontally, directly above the lid of the refuse container, and each cantilever beam pivotably coupled attached at its lower end to a respective left rotator pack and right rotator pack, each rotator pack being an assemblage of metal plates stacked planarly and welded together along their edges; wherein
(b) the metal plates of the left rotator pack comprise a left bracket plate having a left flange, a locking plate, a trigger plate and trigger, a housing plate having an interior wall, a guide plate, and a cover plate, further, each metal plate containing an axle orifice which accommodates the length of a left axle, said left axle further extending through an axle orifice within a left footing of the left cantilever beam and the axle culminating in a weld to the outermost cover plate, the left rotator pack being affixed to the front wall of the refuse container by means of permanent attachment at the left flange;
(c) the metal plates of the right rotator pack comprise a right bracket plate having a right flange, a locking plate, a trigger plate and trigger, a housing plate, a guide plate, and a cover plate, further, each metal plate contains an axle orifice, which accommodates the length of a right axle, said right axle further extending through an axle orifice within the right footing of the right cantilever beam, with a right axle culminating in a weld at the outermost cover plate, the right rotator pack being affixed to the front wall of the refuse container by means of permanent attachment through the right flange; whereby,
(d) with the refuse container at static rest atop a flat surface, a stainless steel ball rests atop the catch of the left cantilever beam, abuts the rear interior wall of the housing plate, is restrained on one side by the locking plate and on its opposite side by the cover plate; whereupon,
(e) lifting and forward tilting of the refuse container allows gravity to roll the stainless steel ball downward along the left arc of the left cantilever beam, roll to the distal end of the second channel of the adjacent guide plate and the distal end of the first channel of the locking plate, thereby freeing the left cantilever beam to pivot and fully pull the horizontal restraining bar away from its position above the top lie.

6. The gravity-actuated device of claim 5 wherein the left rotator pack has a locking mechanism comprising (a) a first metal plate having a pivotable trigger with a padlock opening and (b) a second, adjacent metal plate, having integral to its bottom edge, a padlock entry tab with a padlock opening, whereupon positioning both padlock openings coaxially and inserting a shackle of a padlock through both padlock openings restricts the trigger, blocks the stainless-steel ball from rolling, and prevents pivoting of the cantilever beam, effectively preventing opening of the lid.
